(19) United States
(12) Patent Application Publication
(10) Pub. No.: US 2019/0070835 A1
(43) Pub. Date: Mar. 7, 2019

(54) MULTI-LAYERED FLAME RETARDANT AND CHEMICAL RESISTANT COMPOSITES AND METHODS OF MAKING AND USING THE SAME

(71) Applicant: Precision Fabrics Group, Inc., Greensboro, NC (US)

(72) Inventors: Ladson L. Fraser, High Point, NC (US); Samuel Mark Gillette, Burlington, NC (US)

(21) Appl. No.: 16/082,549

(22) PCT Filed: Mar. 14, 2017
(86) PCT No.: PCT/US17/22251

§ 371 Date: Sep. 6, 2018

Related U.S. Application Data
(60) Provisional application No. 62/310,328, filed on Mar. 18, 2016.
(60) Provisional application No. 62/383,030, filed on Sep. 2, 2016.
(60) Provisional application No. 62/451,156, filed on Jan. 27, 2017.

(51) Int. Cl. B32B 27/12; B32B 7/12; B32B 5/02; B32B 27/08; B32B 27/20; B32B 27/30; B32B 5/08

(52) U.S. Cl. CPC B32B 27/12; B32B 2571/00; B32B 5/022; B32B 27/08; B32B 27/20; B32B 27/304; B32B 27/306; B32B 5/08; B32B 2260/021; B32B 2262/0276; B32B 2262/067; B32B 2262/14; B32B 2307/3065; B32B 2437/00; B32B 7/12

(57) ABSTRACT

A multi-layered flame retardant and chemical resistant composite is described along with methods of making and/or using the same. The composite may be used in protective apparel and/or personal protective ensembles (PPE). The composite may be an engineered textile laminate. The composite may meet NFPA 2113 criteria as an over-garment for NFPA 2112 Flashover protection PPE garments. The composite may provide optimized protection to primary flashover rated PPE, where flames are present, and where chemical hazards are present.

### RELATED APPLICATION INFORMATION

This application claims the benefit of U.S. Provisional Patent Application Ser. Nos. 62/310,328, filed Mar. 18, 2016; 62/383,030, filed Sep. 2, 2016; and 62/451,156, filed Jan. 27, 2017, the disclosure of each of which is incorporated herein by reference in its entirety.

### FIELD

The present invention relates generally to multi-layered flame retardant and chemical resistant composites and to methods of making and/or using the same, such as, for example, for use in protective apparel and/or personal protective ensembles (PPE).

### BACKGROUND

Protective apparel and/or PPEs may be desirable or required for users in a variety of fields (e.g., government, law enforcement/first responder agencies, petroleum rigs, refineries, or various industries requiring NFPA 2112 flashover protection PPE) in some instances, the protective apparel and/or PPE must meet NFPA standards. For example, the garment may need to be a primary NFPA 2112 garment, which may particularly be needed in law enforcement or in other first responder situations where longer duration protection to chemical splash hazards, and associated flame hazards are common.

### SUMMARY OF EXAMPLE EMBODIMENTS

One aspect of the present invention includes a multi-layered composite comprising: a first layer comprising a nonwoven fabric; a second layer comprising a non-flame retardant chemical barrier polymeric film; and a third layer comprising a polymeric film; wherein the first layer is adhered to the second layer with a first flame retardant adhesive and the second layer is adhered to the third layer with a second flame retardant adhesive. In some embodiments, the composite may be a laminate. The non-flame retardant chemical barrier polymeric film provides an excellent chemical barrier that may have flame resistant properties, but does not comprise a flame retardant additive within the chemical barrier polymeric film.

Another aspect of the present invention includes a multi-layered composite comprising: a first layer comprising a nonwoven fabric; a second layer comprising a non-flame retardant chemical barrier polymeric film; and a third layer comprising a polymeric film; wherein the first layer is adhered to the second layer with a first adhesive. In some embodiments, the first adhesive is not a flame retardant adhesive. In some embodiments, the first adhesive is a flame retardant adhesive. In some embodiments, no adhesive is between the second layer and third layer and a surface of the second layer directly contacts a surface of the third layer. In some embodiments, the third layer is applied as a polymeric coating onto a surface of the second layer to form the polymeric film on the second layer. In some embodiments, the composite may be a laminate.

A further aspect of the present invention includes a composite that passes NFPA 701-2015 Method 1 and/or meets the requirements of NFPA 2113. In some embodiments, the composite has at least 12.0 pounds of grab tensile according to INDA IST 110.3-92

In some embodiments, the composite has a chemical hold out of at least 8 hours in accordance with ASTM F23 F739 and ISO 6529/EN 14325 Chemical Permeation using at least one chemical in ASTM F23 F1001 list.

Another aspect of the present invention includes a multi-layered composite comprising: a first layer comprising a nonwoven fabric; a second layer comprising a non-flame retardant chemical barrier polymeric film; and a third layer comprising a flame retardant coating; wherein the first layer is adhered to the second layer with a first flame retardant adhesive and the second layer is adhered to the third layer with a second flame retardant adhesive.

A further aspect of the present invention includes use of a composite of the present invention in a protective garment (e.g., protective apparel and/or PPE).

Another aspect of the present invention includes a method of preparing a composite of the present invention.

The foregoing and other aspects of the present invention will now be described in more detail including other embodiments described herein.

### BRIEF DESCRIPTION OF THE DRAWINGS

FIG. 1 illustrates a composite according to example embodiments of the present invention.

FIG. 2 illustrates a further composite according to example embodiments of the present invention.

FIG. 3 illustrates an example composite according to example embodiments of the present invention.

FIG. 4 illustrates a further example composite according to example embodiments of the present invention.

FIG. 5 illustrates a 2 Mil Coextruded 7 layer Polyethylene/EVOH/Polyethylene film composite according to example embodiments of the present invention.

### DETAILED DESCRIPTION OF EXAMPLE EMBODIMENTS

The present invention will now be described more fully hereinafter. This invention may, however, be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety. In case of a conflict in terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps “and those that do not materially affect the basic and novel characteristic(s)” of the claimed invention. See, In re Herz, 537 F.2d 549, 551-52, 190 U.S.P.Q. 461, 463 (CCPA 1976) (emphasis in the original); see also MPEP § 2111.03. Thus, the term “consisting essentially of” as used herein should not be interpreted as equivalent to “comprising.”

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

As used herein, the term “osy” refers to weight per area unit in ounces per square yard.

As used herein, the term “gsm” refers to weight per area unit in grams per square meter.

As used herein, the term “mil” refers to a thickness in 1/1000 inches.

As used herein, “flame resistant” in reference to a composite, film, layer, and/or fabric refers to the ability of the composite, layer, and/or fabric to pass at least one flame resistance test set forth by the National Fire Protection Association in “NFPA 701 Standard Methods of Fire Tests for Flame-Resistant Textiles and Films,” 2015 Method 1, 1 st Ed. and “NFPA 701 Standard Methods of Fire Tests for Flame-Resistant Textiles and Films,” 1989 Small Scale Ed. The entire contents of each of these NFPA publications is incorporated herein by reference in their entirety.

For purposes of this invention, a flame retardant is a non-polymeric additive or blend of additives used to impart or increase flame resistance properties of an article or material.

For purposes of this invention, a flame retardant composite, film, fabric, and/or layer refers to a composite, film, fabric, and/or layer that comprises a flame retardant. A flame retardant composite, film, fabric, and/or layer of the present invention passes at least one flame resistance test set forth by the National Fire Protection Association in “NFPA 701 Standard Methods of Fire Tests for Flame-Resistant Textiles and Films,” 2015 Method 1, 1st Ed. and “NFPA 701 Standard Methods of Fire Tests for Flame-Resistant Textiles and Films,” 1989 Small Scale Ed. A composite, film, fabric, and/or layer of the present invention may incorporate a flame retardant within the composite, film, fabric, and/or layer and/or on a surface of the composite, film, fabric, and/or layer. In some embodiments, a composite, film, fabric, and/or layer comprises a flame retardant in an amount sufficient such that the composite, film, fabric, and/or layer passes at least one flame resistance test set forth by the National Fire Protection Association in “NFPA 701 Standard Methods of Fire Tests for Flame-Resistant Textiles and Films,” 2015 Method 1, 1st Ed. and “NFPA 701 Standard Methods of Fire Tests for Flame-Resistant Textiles and Films,” 1989 Small Scale Ed.

Provided herein is a composite that includes multiple different layers. A composite of the present invention may include at least two layers. In some embodiments, a composite of the present invention includes at least three layers. For purposes of this invention, the side of a composite and/or garment that may face a user is referred to herein as the inner layer. The side of a composite and/or garment that may face away from the user is referred to herein as the outer layer.

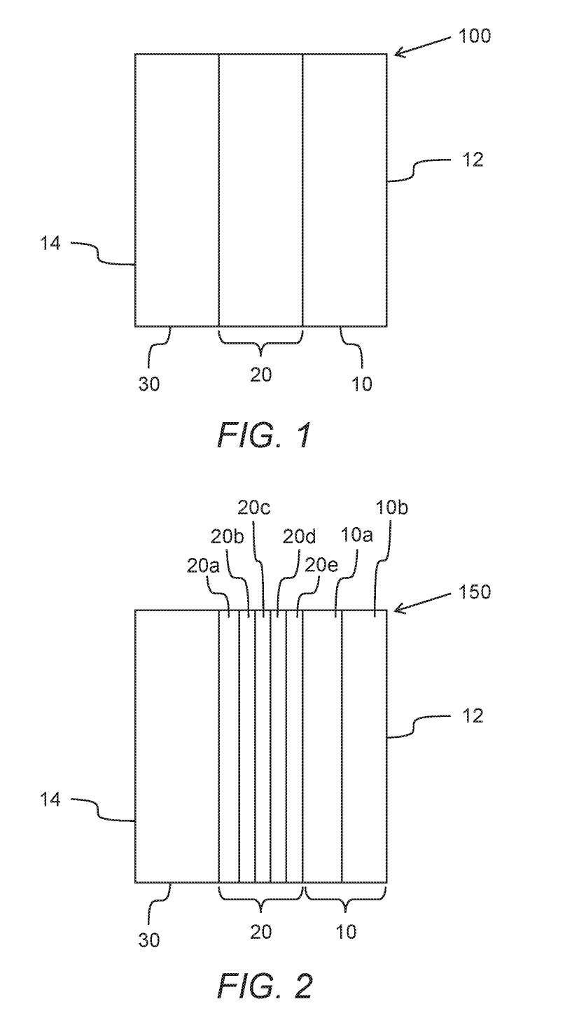

For example, as shown in FIG. 1, a composite 100 of the present invention may comprise a first layer 10, a second layer 20, and a third layer 30. The first layer 10 of composite 100 may comprise a nonwoven fabric, as described herein, which may char when burned and/or exposed to heat and/or flame. The first layer 10 may include a surface 12 that is the inner layer of the composite 100. The second layer 20 may be a non-flame retardant chemical barrier film, as described herein, which may be engineered and/or selected to meet the chemical holdout requirements in accordance with ASTM F23 F739 test procedure and the ASTM F23 F1001 chemical insult list. The second layer 20 may be adhered to the third layer 30, which may comprise a film (e.g., a flame retardant film or a non-flame retardant film), as described herein. The third layer 30 may include a surface 14 that is the outer layer of the composite 100. The first layer 10, second layer 20, and third layer 30 may each be adhesively bonded to an adjoining layer using an adhesive (e.g., a flame retardant adhesive), as described herein.

In some embodiments, a composite of the present invention may be resistant to ASTM F-1001 chemicals in liquid and/or vapor form and may be flame resistant. In some embodiments, the composite may be impervious to water and/or dry particles.

In some embodiments, the composite may comprise and/or may be a laminate. The composite may be referred to herein as a “laminated composite”. The composite may have a basis weight in a range of about 0.5 ounces per square yard (osy) to about 14 osy, such as, for example, about 5 osy to about 10 osy or about 1 osy to about 8 osy. In some embodiments, the composite may have a basis weight of about 0.5, 1, 1.5 5, 5.5, 6, 6.5, 7, 7.5, 8, 8.5, 9, 9.5, or 10 osy. The composite may have a thickness in a range of about 0.001 to about 0.5 inches, such as, for example about 0.005 to about 0.05 inches.

The first layer of a composite of the present invention may comprise a nonwoven fabric comprising a fire retardant additive. In some embodiments, the fire retardant additive may be applied to at least one surface of the nonwoven fabric. The nonwoven fabric may comprise natural fibers (e.g., cellulosic fibers) and/or synthetic fibers. In some embodiments, one side of the nonwoven fabric may comprise natural fibers (e.g., cellulosic fibers) and the other side of the nonwoven fabric may comprise synthetic fibers. Synthetic fibers and natural fibers may be present in a ratio of about 5:1, 2:1, 1.5:1, 1:1, 1:1.5, 1:2, or 1:5 (synthetic fibers:natural fibers). In some embodiments, the ratio of synthetic fibers to natural fibers is in a range of about 1:1 to about 1:1.5. The first layer of a composite of the present invention may have a basis weight in a range of about 1 osy to about 4 osy. In some embodiments, the first layer may have a basis weight of about 1, 1.5, 2, 2.5, 3, 3.5, or 4 osy. In some embodiments, the first layer of a composite of the present invention may make up about 8% to about 50% by weight of the composite, such as, for example, about 20% to about 35%, about 25% to about 45%, or about 15% to about 40% by weight of the composite.

Example nonwoven fabrics that may be used in the first layer of a composite of the present invention include, but are not limited to, spunlace fabrics, spunbond fabrics, spunbond-containing fabrics, spinlace fabrics, resin bonded fabrics, thermal bonded fabrics, air-laid pulp fabrics, stitchbonded fabrics, needlepunch fabrics, and/or other possible engineered materials maintaining preferred physical integrity and synergism for final attributes desired, such as, for example, as described in the Definition of Nonwovens prescribed by INDA.org. In some embodiments, the nonwoven fabric is a spunlace fabric. The nonwoven fabric (e.g., a spunlace fabric) may be made and/or prepared from a combination of cellulosic and synthetic fibers. Example cellulosic fibers that may be used to form a nonwoven fabric (e.g., spunlace fabric) include, but are not limited to, woodpulp fibers, cotton fibers, regenerated cellulose fibers such as rayon and/or lycocell fibers, cellulose acetate fibers, cellulose triacetate fibers, jute, hemp, and/or any bast, leaf, or stem fibers, in some embodiments, the first layer comprises woodpulp fibers.

Synthetic fibers that may be used to form the nonwoven (e.g., spunlace) fabric include, but are not limited to, polyester, nylon, polypropylene, polylactic acid (PLA) fibers, acrylic fibers, and/or any other applicable available textile staple fiber that produces desired attributes, and/or fits a nonwoven (e.g., spunlace) process. In some embodiments, the first layer comprises polyester fibers.

In some embodiments, the first layer comprises a fiber that is treated with a flame retardant additive and the fiber is selected from polyester, nylon, acrylic, acrylonitrile, olyolefin, vinylidene chloride (saran), cellulose (e.g., acetate, rayon, lyocell, woodpulp, cotton and/or other natural organic fibers), silica-containing rayon, melamine (basofil), aramid/paraaramid (e.g., kevlar, nomex), sulfar, polyethylene, olefin, PEU (e.g., spandex), silicone, fluorocarbon, polybenzimidazole (PBI), and/or carbon fibers.

In some embodiments, when the nonwoven layer comprises synthetic fibers and cellulosic fibers, the cellulosic and synthetic fibers may be in the form of flat layers. For example, a nonwoven layer may comprise two or more layers (e.g., 2, 3, 4 or more layers, also referred to herein as sublayers) each of which may comprise cellulosic fibers and/or synthetic fibers in any orientation or order. Referring to FIG. 2, composite 150 may comprise a first layer 10 comprising a nonwoven layer that comprises two layers 10a, 10b, and one layer may comprise cellulosic fibers and the other layer may comprise synthetic fibers. In some embodiments, nonwoven layer 10a (i.e., the nonwoven layer closest to the second layer 20) may comprise cellulosic fibers (e.g., woodpulp fibers) and nonwoven layer 10b may comprise synthetic fibers (e.g., polyester fibers). In some embodiments, nonwoven layer 10b is the inner layer that faces towards a user.

In some embodiments, when the nonwoven layer comprises synthetic fibers and cellulosic fibers, the cellulosic fibers may be in the form of sheets of paper and the synthetic fibers may be in the form of air-laid or carded webs of staple fibers or a nonwoven sheet of substantially continuous filaments. The webs or sheets may be bonded or non-bonded. In some embodiments, the weight ratio of the cellulosic fibers to synthetic fibers in a first layer of a composite of the present invention may range from 75:25 to 25:75, and in some embodiments from 65:35 to 50:50.

The weight of the nonwoven fabric (e.g., spun-lace fabric) used in a composite of the present invention may be selected by the degree of dimensional stability needed and/or desired as well as wear durability needed or desired for a particular application (e.g., for protective apparel applications). In some embodiments, a weight range for the nonwoven fabric (e.g., spunlace fabric) may be about 1.0 osy to about 4.0 osy. An example spunlace woodpulp/polyester fabric that may be used in a composite of the present invention is commercially available from Jacob Holm Industries under the tradename Sontara®.

In some embodiments, the nonwoven fabric may be formed by a spunlacing process. Example spunlace processes are known in the art. For example, a pulp containing cellulosic sheet may be applied to one side of a batt of carded synthetic fibers. The material may then be passed under a plurality of water jets, which entangle the synthetic and cellulosic fibers to form a fabric. Methods of making spunlace fabrics are described in U.S. Pat. No. 4,442,161, the entire contents of which is incorporated herein by reference in its entirety.

A fire retardant additive may be applied to at least one surface of the nonwoven fabric (e.g., spunlace fabric) at a dry solids add-on ranging from about 5 to about 45 percent by weight of the nonwoven fabric. In some embodiments, the dry solids add-on ranges from about 15 to about 25 percent by weight of the nonwoven fabric. Any suitable inorganic and/or organic fire retardant additive may be used. Example inorganic fire retardant additives, include, but are not limited to, ammonium polyphosphates, ammonium dihydrogen phosphate, antimony trioxide, sodium antimonate, zinc borate, zirconium oxides, diammonium phosphate, sulfamic acid, salts of sulfamic acid, boric acid, salts of boric acid, and/or hydrated alumina.

Example organic fire retardant additives that may be used include, but are not limited to, urea polyammonium phosphate, chlorinated paraffins, tetrabromobisphenol-A and oligomers thereof, decabromodiphenyl oxide, hexabromodiphenyl oxide, pentabromodiphenyl oxide, pentabromotoluene, pentabromoethylbenzene, hexabromobenzene, pentabromophenol, tribromophenol derivatives, perchloropentanecyclodecane, hexabromocyclodecone, tris(2,3-dibromopropyl-1)isocyanurate, tetrabromobisphenol-S and derivatives thereof, 1,2-bis(2,3,4,5,6-pentabromophenoxy)ethane, 1,2-bis-(2,4,6-tribromophenoxy)ethane, brominated styrene oligomers, 2,2-bis-(4(2,3-dibromopropyl)3,5-dibromophenoxy)propane, tetrachlorophthalic anhydride, and/or tetrabromophthalic anhydride.

In some embodiments, a combination of fire retardant additives (e.g., inorganic and/or organic) may be used. In some embodiments, a nonwoven fabric may comprise a fire retardant additive that comprises a phosphate, such as, e.g., Spartan 880 FR sold by Spartan Flame Retardants, Inc. The fire retardant additive may be applied to the nonwoven fabric by any conventional method such as, e.g., spraying, contacting the spunlace fabric with a saturation pad or saturation roller, a dip/nip saturation process, gravure coating, kiss coating, and/or the like.

The nonwoven fabric, either before and/or after it is treated with a fire retardant additive, may be laminated to another layer of a composite of the present invention. Referring again to FIG. 1, the first layer 10 comprising the nonwoven fabric may be adhered to the second layer 20 with an adhesive (e.g., a flame retardant adhesive). In some embodiments, the adhesive adhering the first layer 10 to the second layer 20 is not a flame retardant adhesive. The second layer 20 of the composite 100 may comprise a non-flame retardant chemical barrier polymeric film (i.e., the chemical barrier polymeric film is unfilled with a flame retardant additive). Thus, the non-flame retardant chemical barrier polymeric film does not comprise a flame retardant additive within the chemical barrier polymeric film. In some embodiments, a surface of the non-flame retardant chemical barrier polymeric film and/or second layer of a composite of the present invention may be in contact with a flame retardant additive that is part of another layer of the composite (e.g., the first layer or a flame retardant adhesive), but a flame retardant additive is not within the non-flame retardant chemical barrier polymeric film and/or second layer.

In some embodiments, the second layer 20 may comprise 1, 2, 3, 4, 5, 6, 7, 8, 9, 10, or more layers, and when there are two or more layers, each layer may comprise the same material or a different material than another layer. For example, as shown in FIG. 2, in some embodiments, the second layer 20 may comprise one or more layers 20a-20e that may be the same or a different material compared to another layer of the second layer 20.

For the non-flame retardant chemical barrier polymeric film of a composite of the present invention, the primary criterion for selection of this layer may be its chemical barrier properties. Secondary criteria for selection of the non-flame retardant chemical barrier polymeric film may include, e.g., basis weight, handle-o-meter, thickness, cost and/or flame resistant properties, which may be subordinated to achieve the chemical barrier properties of this layer. The non-flame retardant chemical barrier polymeric film of a composite of the present invention may have a basis weight in a range of about 0.25 osy to about 3 osy. In some embodiments, the non-flame retardant chemical barrier polymeric film may have a basis weight of about 0.25, 0.5, 0.75, 1, 1.25, 1.5, 1.75, 2, 2.25, 2.5, 2.75, or 3 osy. In some embodiments, the non-flame retardant chemical barrier polymeric film of a composite of the present invention may make up about 7.5% to about 45% by weight of the composite, such as, for example, about 10% to about 35% or about 15% to about 25% by weight of the composite.

The non-flame retardant chemical barrier polymeric film of a composite of the present invention may serve as a barrier against liquids, solids, and/or gases. The non-flame retardant chemical barrier polymeric film may be referred to herein as the second layer of the composite and may be a chemical barrier layer. The non-flame retardant chemical barrier polymeric film may by itself have some degree of flame resistance. Flame resistance may be measured by flame testing and/or by determining the limiting oxygen index. For example, the non-flame retardant chemical barrier polymeric film may by itself have some degree of flame resistance if the non-flame retardant chemical barrier polymeric film comprises barrier polymers that have a Limiting Oxygen Index (LOI) greater than 27 as measured by ASTM D7348-13 and similar methods. In some embodiments, a flame retardant is incorporated with a polymer to reduce the tendency for combustion. In some embodiments, the innate properties of a polymer make it resistant to combustion.

In some embodiments, the non-flame retardant chemical barrier polymeric film of a composite of the present invention may be a continuous iayer. The non-flame retardant chemical barrier polymeric film may not comprise any or may have minimal open pores and/or holes within the film. Discontinuities in the non-flame retardant chemical barrier polymeric film, such as, for example, open pores and/or holes, are not desired as they may allow the insult chemical/permeant to migrate through the non-flame retardant chemical barrier polymeric film. A continuous non-flame retardant chemical barrier polymeric film and/or layer thereof may be achieved by methods known to those of skill in the art including, but not limited to, extruding a film of a polymer, blowing a film of a polymer, and/or applying or printing a polymer in a pattern of discreet points and providing a method for the individual points to coalesce together such as, e.g., using a solvent, heat, etc.

The non-flame retardant chemical barrier film may comprise 2 or more layers (e.g., 2, 3, 4, 5, 6, 7, 8, or more), which may be chosen to prevent the passage of chemicals. In some embodiments, the non-flame retardant chemical barrier film comprises at least three layers. In some embodiments, the non-flame retardant chemical barrier film may comprise at least two layers (e.g., 2, 3, 4, 5, 6, 7, 8, or more) and the at least two layers may be contiguous and/or continuous.

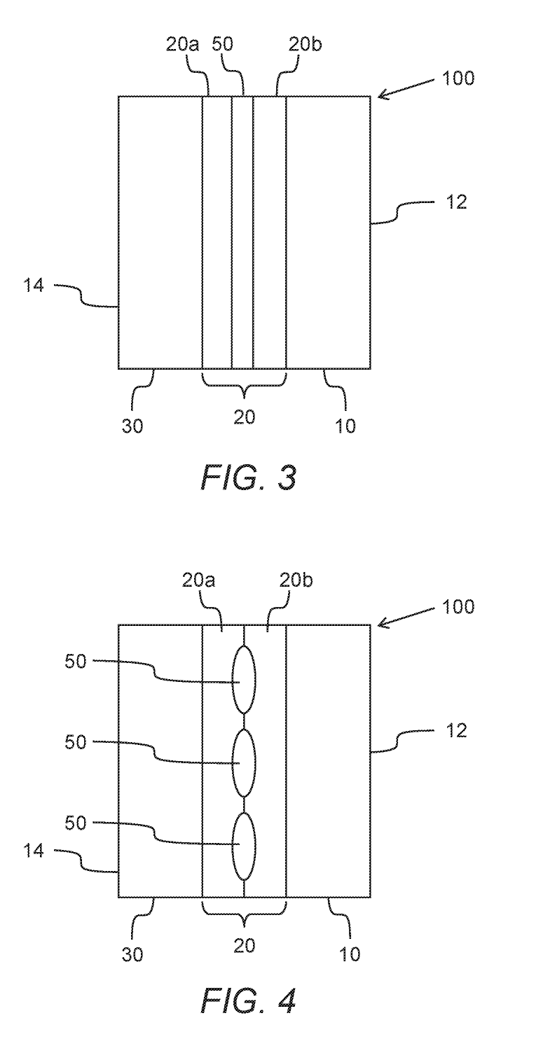

In some embodiments, the effectiveness of the non-flame retardant chemical barrier film in preventing penetration and/or permeation of chemicals (e.g., liquid and/or gaseous) and/or biological hazards may be improved by introducing spaces and/or absorbent media between two or more layers of the non-flame retardant chemical barrier film. For example, as shown in FIG. 3, a space and/or absorbent media (e.g., a fabric) 50 may be positioned between a first layer 20a of the non-flame retardant chemical barrier film 20 and a second layer 20b of the non-flame retardant chemical barrier film 20. The space and/or absorbent media may create a reservoir, which may take up a liquid and/or gas, and/or the space and/or absorbent media may reduce the pressure gradient. In some embodiments, the space and/or absorbent media may create an insulation effect. In some embodiments, including a space and/or absorbent media between two or more layers of the non-flame retardant chemical barrier film 20 may create a tortuous path for a chemical (e.g., liquid and/or gaseous) and/or biological hazard. The space and/or absorbent media may be discontinuous as shown, for example, in FIG. 4. As shown in FIG. 4, portions of the first layer 20a and the second layer 20b of the non-flame retardant chemical barrier film 20 are contiguous, while other portions are noncontiguous as a space and/or absorbent media 50 is between a portion of the first layer 20a and the second layer 20b of the non-flame retardant chemical barrier film 20. Spaces and/or absorbent media may be arranged in a symmetrical pattern or asymmetrical pattern (e.g., be randomly distributed). For example, referring to FIG. 4, an adhesive may be arranged in a symmetrical or asymmetrical pattern between the first layer 20a and the second layer 20b of the non-flame retardant chemical barrier film 20, and the contiguous portions of the first layer 20a and the second layer 20b may be bound together using the adhesive. In some embodiments, the noncontiguous portions may be areas where the adhesive is not present or applied so that a space 50 is provided.

The chemical resistance of the non-flame retardant chemical barrier film may be enhanced by alternating several types of polymer layers within the film and/or by adding additional layers of film. In some embodiments, additional polyethylene layers may be added to the non-flame retardant chemical film to enhance protection against polar solvents. Other layers may include, but are not limited to, ethylene vinyl alcohol (EVOH), nylon (e.g., nylon 6 and/or nylon 6,6), polyolefins (e.g., polypropylene (PP)), polyethylene (PE) (e.g., polyethylene high density and/or polyethylene low density), polyvinylidene chloride (PVDC) (e.g., Saranex®), polyvinylfluoride (PVF) (e.g., Tedlar®), acrylic, acrylonitrile rubber, butyl rubber, chlorosulfonated polyethylene (e.g., Hypalon®), ethylene chlorotrifluoroethylene copolymer (ECTFE) (e.g., Halar®), ethylene propylene diene monomer (M-class) rubber-coatings (EPDM rubber), fluorinated ethylene propylene (FEP), fluoro-elastomer polymers (e.g., Viton®), liquid crystal polymers, metal foils, natural rubber, neoprene, perfluoroalkoxy copolymer (e.g., Teflon® PFA), polimide, polyamide-imide (e.g., Tecator® and Torlon®), polyamides, polesters (e.g., Mylar®), polyether sulfone, polyetheretherketone (PEEK, e.g., Victrex®), polyetherimide, polymeric coatings, polyphenylsulfone (PPS), polysulfone, polytetrafluoroethylene (PTFE) (e.g., Teflon®), polyurethane, polyvinyl chloride (PVC), polyvinylidene fluoride (PVDF) (e.g., Kynar®) poylvinyl choride-acetate (PCA), styrene butadiene rubber (SBR), vacuum metallized films, extrudable polymers that are used for chemical barrier films in the market place, and/or any variation, combination and/or hybridization thereof. Commercial examples of chemical barrier films include, but are not limited to, those that are available from companies such as IsoFlex, Berry Plastics, Mitsui, Filcon, Kuraray and/or Optimum Plastics. In some embodiments, the second layer comprises PEEK, polyethylene, polyolefin, ECTFE, PVF, nylon, EVA, EVOH, polypropylene, polyester, and/or ethylene-vinyl chloride (EVCL).

In some embodiments, the layers within the non-flame retardant chemical barrier film may provide a good barrier to oxygen and may also provide a good barrier to some solvents, acids and/or bases. In some embodiments, the incorporation of flame retardant fillers into a chemical barrier film may reduce the chemical barrier properties of the film. The non-flame retardant chemical barrier film may comprise flame-resistant polymers which may complement properties of the present invention.

In some embodiments, a component (e.g., polymer) for preparing and/or forming the non-flame retardant chemical barrier film may be selected by the component having a low affinity for the insult chemical(s) of interest (i.e., the chemical(s) for which protection and/or a barrier against is desired). A composite of the present invention may comprise a non-flame retardant chemical barrier film that has a low solubility to the insult chemical and/or that may be relatively insoluble to the insult chemical. Solubility (or insolubility) can be determined and/or estimated by comparing the solubility parameter of a component (e.g., a polymer) with that of an insult chemical's. If they are sufficiently different, then a non-flame retardant chemical barrier film comprising the component may function as a barrier since the insult chemical is not soluble in the barrier film and may not migrate through it. In some embodiments, the non-flame retardant chemical barrier film has at least one layer that has at least one difference in solubility parameter that is about 3.0 (calories per cm³)^{1/2} or greater, such as, for example, about 3, 3.5, 4, 4.5, 5, 5.5, 6, 6.5, 7, 7.5, 8, 8.5, 9, 9.5, 10, 10.5, 11, 11.5, 12, 12.5. 13, 13.5, 14, 14.5, 15, 15.5, 16, 16.5, 17, 17.5, 18, 18.5, 19, 19.5, 20 (calories per cm³)^{1/2}, or greater for a chemical, such as, e.g., a chemical is listed in ASTM F23 F1001.

If a non-flame retardant chemical barrier film functions to block the migration of an insult chemical, then this may be attributed to the polymer film with the greatest difference in solubility parameter from the insult. For example, a polymer film of EVOH may be responsible for blocking the migration of acetone since the difference in solubility parameter between EVOH and acetone is 3.1 (calories per cm³)^{1/2} while the difference in solubility parameter between PE and acetone is only 1.9 (calories per cm³)^{1/2}. Thus. PE has a smaller difference in solubility parameter compared to EVOH and may not function as well as a barrier film against acetone compared to an EVOH barrier film.

In some embodiments, the non-flame retardant chemical barrier film is not physically and/or chemically disrupted by the insult chemical and/or the non-flame retardant chemical barrier film exhibits slow or no diffusion of the insult chemical through the non-flame retardant chemical barrier film.

Referring again to FIG. 1, the second layer 20 comprising a non-flame retardant chemical barrier film may be adhered to the third layer 30 of the composite 100 with an adhesive (e.g., a flame retardant adhesive). In some embodiments, no adhesive is used to adhere the second layer 20 to the third layer 30. In some embodiments, the third layer 30 is a polymeric coating (optionally a flame retardant coating) that is applied onto the second layer 20 with no adhesive between so that a surface of the second layer 20 directly contacts a surface of the third layer 30. The polymeric coating (optionally a flame retardant coating) may form a film (e.g., a polymeric film), in some embodiments, the third layer 30 may comprise a polymeric film (optionally a flame retardant film). In some embodiments, the third layer 30 may be and/or comprise an outer layer, such as, e.g., an outer flame and/or splash barrier layer.

A third layer and/or outer layer of a composite of the present invention may have at least some degree of flame resistance and/or chemical resistance. In some embodiments, the third layer in a composite of the present invention may comprise a fire retardant additive. In some embodiments, the third layer does not comprise a fire retardant additive.

Example polymers that may be present in the third layer include, but are not limited to, polyvinylidene chloride, chlorinated polyethylene (CPE), PVC, ethyl methyl acrylate (EMA), acrylic polymers, acrylonitrile rubber, poly(ester urethanes) (PEU), PEEK, polyethylene, polyolefin, ECTFE, PVF, nylon, EVA, EVOH, polypropylene, polyester, and/or EVCL. In some embodiments, the third layer of a composite of the present invention may comprise a halogenated polymer, such as, for example, polyvinyl chloride, polyvinyl bromide, polyvinyl fluoride, and/or polyvinylidene chloride (PVDC). In some embodiments, the third layer may not comprise inherently flame resistant polymers, but may be rendered flame resistant by the application of sufficient fire retardant additives within the film itself and/or within the flame retardant adhesive binding the third layer to the non-flame retardant chemical barrier polymeric film, thereby effectively rendering the third layer flame retardant. In some embodiments, the third layer may comprise polyvinyl chloride. In some embodiments, a composite of the present invention does not comprise polyvinyl fluoride or butyl rubber.

In some embodiments, the third layer comprises a polymer selected from PEEK, polyethylene, polyolefin, ECTFE, PVF, nylon, EVA, EVOH, polypropylene, polyester, EVCL, and/or PVC, and optionally comprises a flame retardant additive. In some embodiments, the third layer is applied a polymeric coating that comprises polyvinylidene chloride, chlorinated polyethylene (CPE), PVC, ethyl methyl acrylate (EMA), acrylic polymers, acrylonitrile rubber, and/or poly(ester urethanes) (PEU), and optionally comprises a flame retardant additive. A polymeric coating may be applied according to methods known to those of skill in the art. In some embodiments, the polymeric coating may be hot melt extruded onto the second layer and the polymeric coating may comprise, for example, PVDC, CPE, PVC, and/or FR filled EMA. In some embodiments, the polymeric coating may be applied as fluid (e.g., an aqueous liquid) onto the second layer that is subsequently dried and cured, and the polymeric coating may comprise, for example, PVDC, CPE, FR filled acrylic, FR filled acylonitrile rubber, and/or FR filled PEU.

The weight and type of the polymeric film of the third layer may be selected to be complementary to the non-flame retardant chemical barrier polymeric film in order to achieve the desired properties for the overall composite. In some embodiments, the third layer of a composite of the present invention may have a thickness in a range of about 0.0001 inches to about 0.008 inches. In some embodiments, the third layer of a composite of the present invention may have a thickness in a range of about 0.2 mils (1 mil=0.001 inches) to about 6.0 mils. The thickness of the third layer may depend on the end use, and may be optimized to control the composite's strength, abrasion resistance, and/or barrier properties for an intended end use while being cost effective. The third layer of a composite of the present invention may have a basis weight in a range of about 0.05 osy to about 10 osy, such as, for example, about 0.15 osy to about 5 osy or about 1 osy to about 4 osy. In some embodiments, the third layer may have a basis weight of about 0.05, 0.1, 0.25. 0.5, 0.75, 1, 1.5, 2, 2.5, 3, 3.5, 4, 4.5, 5, 5.5, 6, 6.5, 7, 7.5, 8, 8.5, 9, 9.5, or 10 osy. In some embodiments, the third layer a composite of the present invention may make up about 8% to about 50% by weight of the composite, such as, for example, about 15% to about 50% or about 20% to about 45%.

An adhesive (e.g., a flame retardant adhesive) may be used to bind and/or adhere the first layer and second layer and/or the second layer and third layer of a composite of the present invention. In some embodiments, the adhesive may be a flame retardant and/or flame resistant adhesive. In some embodiments, the nonwoven fabric of the first layer may be bonded and/or adhered to the non-flame retardant chemical barrier film of the second layer using an adhesive (e.g., a flame retardant adhesive), which may be applied to a surface of the nonwoven fabric and/or to a surface of the non-flame retardant chemical barrier film. In some embodiments, the adhesive used to bond and/or adhere the non-flame retardant chemical barrier film of the second layer to the first layer is not a flame retardant adhesive, and optionally the non-flame retardant adhesive may be applied onto a surface of the nonwoven fabric and/or onto a surface of the non-flame retardant chemical barrier film in a discontinuous pattern so that a discontinuous adhesive layer is formed between the first layer and second layer. The non-flame retardant chemical barrier film may be bonded and/or adhered to the polymeric film of the third layer using a flame retardant adhesive, which may be applied to a surface of the flame retardant film and/or to a surface of the non-flame retardant chemical barrier film. The adhesive used between the first and second layers and the second and third layers may be the same or may be different. In some embodiments, the adhesive between the first and second layers and the second and third layers may be a flame retardant adhesive that comprises the same fire retardant additive. In some embodiments, the adhesive used to bond and/or adhere the first layer and the second layer together is a non-flame retardant adhesive and no adhesive is used to bond and/or adhere the second and third layers. In some embodiments, the adhesive used to bond and/or adhere the first layer and the second layer is a non-flame retardant adhesive and the adhesive used to bond and/or adhere the second layer and the third layer together is a flame retardant adhesive. In some embodiments, the adhesive may comprise EVA, acrylic (e.g., an elastomeric acrylic), acrylonitrile rubber, poly(vinyl acetate), polyvinyl alcohol, polyester, APAO, PVC, and/or PVDC, and optionally a flame retardant.

A flame retardant adhesive may comprise an adhesive. The term “adhesive” as used herein refers to any binder and/or chemical substance that can hold two layers together and/or cause them to stick together with a measurable force. For example, an adhesive may bond a film to another film that may comprise the same or a different material. Alternatively or in addition, an adhesive may bond a film to a fabric.

In some embodiments, the adhesive may be an aqueous, solvent, hot melt, thermoplastic or thermoset adhesive. Example adhesives that may be used include, but are not limited to, pressure sensitives, polyesters, acrylates, acetates, polyamides, ethylene vinyl acetates (EVAs), ethyl methacrylates (EMAs), polyolefins, thermoplastic polyurethanes, and/or reactive moisture cure urethanes. In some embodiments, the adhesive provides greater than 15 grams of peel strength between the contiguous layers when tested in accordance with ASTM 5170. The adhesive may be inherently flame retardant or may contain an additive that causes the adhesive to be flame retardant and maintain its adhesive properties.

In some embodiments, a flame retardant adhesive may comprise a halogenated flame retardant compound, such as, e.g., an additive and/or binder. A halogenated flame retardant may be combined with various antimony, zinc, and/or aluminate synergists. A halogenated adhesive may be very efficient at extinguishing flames and preventing the spread of flames. However, many halogenated flame retardants have come under regulatory scrutiny. In some embodiments, an adhesive and/or flame retardant may be environmentally friendly. In some embodiments, an aqueous adhesive compound may be used that comprises an acrylic binder, Type II Ammonium Poly Phosphate (APP) or melamine encapsulated APP, and particles of low melt polyester adhesive powder. In some embodiments, a flame retardant adhesive may be foam coated onto the nonwoven fabric and dried, and optionally subsequently it may be reheated to activate the adhesive (e.g., adhesive particles) and pressed against the polymeric film of the second layer to laminate the layers together. Example classes of adhesives that may be used in a composite of the present invention include, but are not limited to, those that comprise a halogen, phosphate, nitrogen, expanded and/or expandable graphite, and/or inorganic materials such as, e.g., aluminum trihydrate (ATH), clays, and/or other minerals.

Any suitable amount of flame retardant may be added to an adhesive. In some embodiments, the dry add on for the flame retardant adhesive is in a range of about 0.1 osy to about 1.5 osy per layer of the composite. The concentration of the flame retardant in the flame retardant adhesive may depend on the type of flame retardant included, in some embodiments, a flame retardant may be present in the flame retardant adhesive in an amount of about 25% to about 80% by weight of the flame retardant adhesive, such as, for example, about 30% to about 70%, about 50% to about 75%, about 55% to about 70%, or about 40% to about 55% by weight of the flame retardant adhesive. In some embodiments, a flame retardant may be present in the flame retardant adhesive in an amount of about 25%, 30%, 35%, 40%, 45%, 50%, 55%, 60%, 65%, 70%, 75%, or 80%. In some embodiments, a flame retardant adhesive may comprise a flame retardant, such as, for example Apexical Flameproof P1F-024, in an amount of about 40% by weight of the flame retardant adhesive.

An adhesive (e.g., a flame retardant adhesive) may be applied to a surface in a manner to provide a pattern or randomly. Some embodiments include that when an adhesive is applied to a surface an adhesive layer may be applied and/or formed. The adhesive layer may be substantially continuous or may be discontinuous and may cover at least about 1% and up to 100% of the surface as measured using microscopic examination of the coated surface. In some embodiments, an adhesive layer may be provided on a surface and the adhesive layer may cover at least about 2%, 5%, 10%, 20%, 30%, 40%, 50%, 60%, 70%, 80%, 90%, 95% or more of the surface. One or more layers of an adhesive (e.g., a flame retardant adhesive) (e.g., 1, 2, 3, 4, 5, or more) may be applied to a surface, which may provide one or more adhesive layers (e.g., 1, 2, 3, 4, 5, or more). In some embodiments, the adhesive may be a flame retardant and/or flame resistant adhesive and may form a layer (e.g. a continuous layer) on a surface of the second layer (e.g., between second layer and third layer) that excludes the non-flame retardant barrier film from oxygen. In some embodiments, after applying an adhesive to a surface (e.g., a surface of one of the layers of the composite), the layers of the composite may be pressed together, which may cause them to stick to each other and/or stay in intimate contact. The process of joining two layers with an adhesive is referred to herein as “adhesive lamination”.

An adhesive (e.g., a flame retardant adhesive) may be applied to a surface using methods known to those of skill in the art. For example, an adhesive may be applied using gravure printing (e.g., aqueous or solvent base media), screen printing, knife over roll coating, spraying, transfer printing, adhesive web, gravure printing hot melt adhesive (e.g., thermoplastic polymer based pressure sensitive adhesive (PSA) or reactive thermoset based, e.g., moisture cure urethane), porous coat hot melt adhesive (e.g., thermoplastic polymer based PSA or reactive thermoset based, e.g., moisture cure urethane), slot coating (thermoplastic polymer based PSA or reactive thermoset based, e.g., moisture cure urethane), and/or powder sprinkling (via Schindler roll).

In some embodiments, an adhesive (e.g., a flame retardant adhesive) in a composite of the present invention may have a basis weight in a range of about 0.01 osy to about 2 osy, such as, for example, about 0.05 osy to about 1 osy or about 0.1 osy to about 0.75 osy. In some embodiments, the adhesive may have a basis weight of about 0.05, 0.1, 0.25, 0.5, 0.75, 1, 1.25, 1.5, 1.75, or 2 osy. In some embodiments, the adhesive in a composite of the present invention may make up about 1% to about 25% by weight of the composite, such as, for example, about 1% to about 20% or about 5% to about 15% by weight of the composite.

In some embodiments, the non-flame retardant barrier film, which may be the second layer in a composite of the present invention, and/or the polymeric film (e.g., a flame retardant outer film), which may be the third layer in a composite of the present invention, may be surface modified to improve interaction with one or more adhesive layers and/or coatings. The surface modification may include processes such as, but not limited to, etching, embossing, plasma treatment, flame treatment and/or corona treatment. The surface modification may be an additional coating or a co-extruded tie layer on one or more surfaces to facilitate bonding to the film. For example, a surface of the non-flame retardant barrier film making up the second layer of a composite of the present invention and/or the polymeric film making up the third layer of the composite may comprise, e.g., adhesive polymers and/or additives such as ethylene vinyl acetate (EVA), maleic anhydride modified polymers, methyl methacrylate containing polymer blends and/or other ingredients known to those skilled in the art of film manufacturing.

In some embodiments, the first layer of a composite of the present invention may be a flame retardant fabric that may contact a user's skin and/or clothing and may be adhered to the second layer using one or more layers of adhesive (e.g., a flame retardant adhesive). The adhesive(s) (e.g., a flame retardant adhesive(s)), the second layer, and/or the third layer may have several distinguishing properties, which may allow the resulting composite to fulfill the intended purpose of a garment. For example, flame retardant properties, chemical permeation resistance, surface abrasion resistance, visual appearance, esthetic properties, and/or other characteristics known to those trained in the art may be incorporated into the composite through the intelligent selection of raw materials. In some embodiments, the nonwoven fabric may comprise at least one layer of flame-resistant fibers such as, e.g., Nomex, Kevlar, Kynol or Basofil fibers, which may be commercially available at 1.25 ounces per square yard fabric weight.

In some embodiments, a composite of the present invention may be a laminate. The laminate may comprise a first layer of a nonwoven fabric (e.g., a nonwoven fabric containing cellulose fibers and synthetic fibers) having a fire retardant additive applied thereto; a second layer of a non-flame retardant chemical barrier polymeric film adhered to the first layer using a first flame retardant adhesive; and a third layer that comprises a polymeric film and is adhered to the second layer using a second flame retardant adhesive. In some embodiments, the fire retardant additive is applied to at least one surface of the nonwoven fabric.

In some embodiments, the laminate may comprise a first layer of a nonwoven fabric (e.g., a nonwoven fabric containing cellulose fibers and synthetic fibers) having a fire retardant additive applied thereto; a second layer of a non-flame retardant chemical barrier polymeric film adhered to the first layer using a first adhesive; and a third layer that comprises a polymeric film and is adhered to the second layer using a second adhesive. In some embodiments, the fire retardant additive is applied to at least one surface of the nonwoven fabric. In some embodiments, the first adhesive is not flame retardant and the second adhesive is a flame retardant adhesive.

In some embodiments, the laminate may comprise a first layer of a nonwoven fabric (e.g., a nonwoven fabric containing cellulose fibers and synthetic fibers) having a fire retardant additive applied thereto; a second layer of a non-flame retardant chemical barrier polymeric film adhered to the first layer using a first adhesive; and a third layer that comprises a polymeric film, wherein no adhesive is used to adhere the third layer to the second layer. In some embodiments, the fire retardant additive is applied to at least one surface of the nonwoven fabric. In some embodiments, the first adhesive is a flame retardant adhesive. In some embodiments, the third layer is adhered to the second layer by applying a polymeric coating directly onto a surface of the third layer and the polymeric coating forms the polymeric film. In some embodiments, the polymeric film comprises a flame retardant.

In some embodiments, the laminate may comprise a first layer of a nonwoven fabric (e.g., a nonwoven fabric containing cellulose fibers and synthetic fibers) having a fire retardant additive applied thereto; a second layer of a non-flame retardant chemical barrier polymeric film adhered to the first layer using a flame retardant adhesive; and a third layer that comprises a flame retardant abrasion resistant coating that has been applied to the non-flame retardant chemical barrier polymeric film. In some embodiments, the fire retardant additive is applied to at least one surface of the nonwoven fabric.

In some embodiments, a composite of the present invention is flame retardant and/or resistant to chemical penetration and/or chemical permeation. In some embodiments, the composite is flame retardant and resistant to both chemical penetration and chemical permeation.

The composite may prevent chemical permeation at or below threshold levels, such as, for example, those as cited in EN 14325 and/or ASTM F23 F739 chemical permeation test(s) when challenged with one or more chemicals (e.g., 1, 2, 3, 4, 5, 6, 7, 8, 9, 10, or more) on the ASTM F23 F1001 list. In some embodiments, the composite may prevent chemical permeation at or below threshold levels, such as, for example, those as cited in EN 14325 and/or ASTM F23 F739 chemical permeation test(s) when challenged with each of the chemicals on the ASTM F23 F1001 list. Alternatively or in addition, the composite may pass the NFPA 701-20.15 Method 1 open flame vertical flammability test.

In some embodiments, a composite of the present invention may have a burn behavior that is self-extinguishing and chat forming with residual integrity and minor weight loss. This type of burn behavior may translate into no contribution to excess body burn as described in NFPA 2113 A.5.1.7 and 8. In these tests, a primary garment meeting NFPA 2112 flash over protection is used as the undergarment and the secondary garment comprises a composite of the present invention which is over the primary garment. In contrast, results of the NFPA 701 2015 Method 1 Flammability Test such as: perpetual after-flame, melting away from flame (thermoplastic material behavior), excessive mass loss of specimen, and burning melted drips tend to translate into a non-compliant over-garment or accessory by NFPA 2113 definition when worn over the primary NFPA 21.12 garment (subjected to the NFPA 2112 thermal manikin test). A secondary garment of the present invention that comprises a composite of the present invention may not exhibit perpetual after-flame, melting away from flame (thermoplastic material behavior), excessive mass loss of specimen, and/or burning melted drips when provided and/or worn over a primary NFPA 2112 garment and subjected to the NFPA 2112 thermal manikin test. It is noted that a thermoplastic material often perpetuates an after flame once the burner insult is over in a thermal manikin test and will sustain an after-flame due to wicking of the melted garment resulting in an increased body burn percentage. In contrast, it was surprisingly discovered that a NFPA 2112 garment covered with a composite and/or garment of the present invention self-extinguishes and goes to a charred solid state. Thus, a composite and/or garment of the present invention may be flame resistant in a self-extinguishing behavior and may form a chat upon open flame insult. Polymers that melt and flow can cause burn injuries and also help to propagate flames. NFPA 701-1989 small scale; NFPA701-2015 M1, as well as ASTM D13 D6413 Textile Vertical Flammability “Method” are useful for determining if materials will char or melt and flow.

In some embodiments, a composite and/or garment of the present invention may have a weight loss of less than about 40%, such as, for example, less than about 35%, 30%, 25%, 20%, 15%, 10%, or 5%, when tested in accordance with NFPA 701-2015 Method 1. In some embodiments, a composite and/or garment of the present invention may have a weight loss in a range of about 1% to about 20%, such as, for example, about 1% to about 15%, when tested in accordance with NFPA 701-2015 Method 1.

Further, it was surprisingly discovered that a composite and/or garment of the present invention may provide chemical penetration and/or chemical permeation resistance and may be compliant to NFPA 2113 requirements. In contrast, commercially available products, such as those at comparable weights to those of the composite and/or garment of the present invention, are non-compliant to NFPA 2113 requirements and may not exhibit good flame resistance. Higher resistance to chemicals, whether gas, liquid or particulate will benefit products designed to pass ASTM F23 F739 (domestic) and EN 14325/ISO 6529-international criteria. The composite and/or garment of the present invention may combine improved chemical resistance and flame resistance into a single light weight composite for use in PPE garments meeting NFPA 2113 and other criteria such as, e.g., NFPA 1991.

A composite and/or garment of the present invention may provide increased or improved flame resistance and/or chemical protection at a reduced material cost per unit compared to existing flame resistant and/or chemical protective garments, such as, for example, DuPont's ChemMAX3. In some embodiments, a composite of the present invention may be used as an outer garment, such as, for example, as a garment that is used, worn, and/or provided over a primary NFPA 2112 garment. The composite may prevent and/or reduce soiling and/or contamination of a primary garment (e.g., a NFPA 2112 primary garment). In some embodiments, when a composite and/or garment of the present invention is exposed as a coverall on top of a manikin fitted with a primary NFPA 2112 ensemble per thermal manikin testing, the percent body burn result meets NFPA 2113 criteria as a compliant accessory.

In some embodiments, a composite and/or garment of the present invention may allow for a reduction of PPE mass, which may contribute to less wearer fatigue (vs. comparable PPE materials, which can be bulky and/or heavier) and/or may provide improved economics for targeted class provided protection. In some embodiments, a composite and/or garment of the present invention may be light weight. A composite of the present invention may have sufficient structural integrity to fabricate a garment, such as, for example, a PPE and/or protective apparel.

In some embodiments, a composite of the present invention may be used to make and/or prepare a garment, such as, for example, a chemically impervious garment. Any suitable method known to those of skill in the art for making garments (e.g., for making chemically impervious garments) using a composite can be used to prepare a garment of the present invention. In some embodiments, a garment of the present invention, which may be prepared using a composite of the present invention, may be useful in applications where PPE must meet NFPA standards. “Garment” as used herein refers to a garment comprising a composite of the present invention. The term “garment” includes any type of protective material and/or device for a user (e.g., an animal (e.g., human), a machine or equipment) and includes, but is not limited to, clothing (e.g., coveralls, suits, gloves, jackets, trousers, etc.), headgear, shoes, blankets (e.g., wrap around blankets), covers, and the like.

In some embodiments, a garment and/or composite of the present invention may be used for and/or in a personal protection ensemble (PPE). The garment and/or composite may be chemical permeation resistant to liquids, solid particles, and/or gases within the scope of the ASTM F23 F739 Chemical Permeation US Domestic test, and International ISO 6529 Chemical Permeation test. In some embodiments, a garment and/or composite of the present invention (i.e., a garment comprising a composite of the present invention) may be used over a NFPA 2112 garment. The garment and/or composite may augment the flame retardant protection of the NFPA 2112 garment. In some embodiments, the garment and/or composite may provide chemical permeation and/or penetration resistance. In some embodiments, a garment and/or composite of the present invention may meet NFPA 2113 requirements, such as, for example, the garment and/or composite may meet NFPA 2113 A.5.1.7 and 8 requirements when used over and/or to cover a primary NFPA 2112 flashover protection compliant garment or device.

According to NFPA 2113 requirements found in Section A.5.1.7 and 8, a secondary cover garment and/or composite of the present invention may provide further splash and/or chemical protection and/or primary flashover flame protection that meets NFPA 2112. Costly primary PPE garments that are NFPA 2112 rated for flashover protection must not be used while contaminated, and if contaminated require costly cleaning and recertification. In some embodiments, a garment and/or composite of the present invention may meet NFPA 2113 (Section A.5.1.7 and 8) criteria and may provide protection to primary NFPA 2112 PPE and the end user from the penetration and/or permeation of harmful chemicals and/or from flash over fires.

A garment and/or composite of the present invention may provide significantly bet-ter chemical permeation resistance and equivalent flash over fire protection, such as, for example, compared to currently available garments in the same limited use labeled garment category. Current PPE garments withstand 60 minutes of chemical liquid penetration in accordance with ASTM F23 F903 test and F1001 liquid chemical list, whereas the materials of the current invention withstand 480 minutes of penetration. In some embodiments, a garment and/or composite of the present invention may withstand at least 60, 90, 120, 150, 180, 210, 240, 270, 300, 330, 360, 390, 420, 450, 480, 510, 540, 570, 600 minutes of chemical liquid penetration in accordance with ASTM F23 F903 test and F1001 liquid chemical list. In some embodiments, a garment and/or composite of the present invention may provide chemical permeation protection for at least 60, 90, 120, 150, 180, 210, 240, 270, 300, 330, 360, 390, 420, 450, 480, 510, 540, 570, 600 minutes of chemical permeation in accordance with ASTM F23 F903 test and F1001 liquid chemical list.

A composite of the present invention may be useful for other various levels of chemical protective garments needing flame resistance, such as, e.g., those used in heavy industry (e.g. welding, equipment manufacturing), hazardous chemical remediation, general laboratory work, electrical utilities (rain-ware, fire protection), the petrochemical industry, pesticide applications, and/or painting. In some embodiments, a composite of the present invention may be formed into a protective cover for machinery and/or equipment. In some embodiments, regardless of the specific end use, a composite of the present invention may be used by itself or in conjunction with one or more additional protective material(s).

For purposes of this invention, a composite of the present invention may comprise either flame retardant or flame resistant materials, or may comprise a combination of flame retardant and flame resistant materials. For purposes of this invention, the use of flame retardant and flame resistant materials may be varied depending on the end use requirements of the composite. In some embodiments, materials may be incorporated into a composite that are neither flame resistant nor flame retardant as long as the composite meets the requirements of the end use application and passes the desired testing standards.

The present invention is explained in greater detail in the following non-limiting Examples.

### EXAMPLES

### Example 1

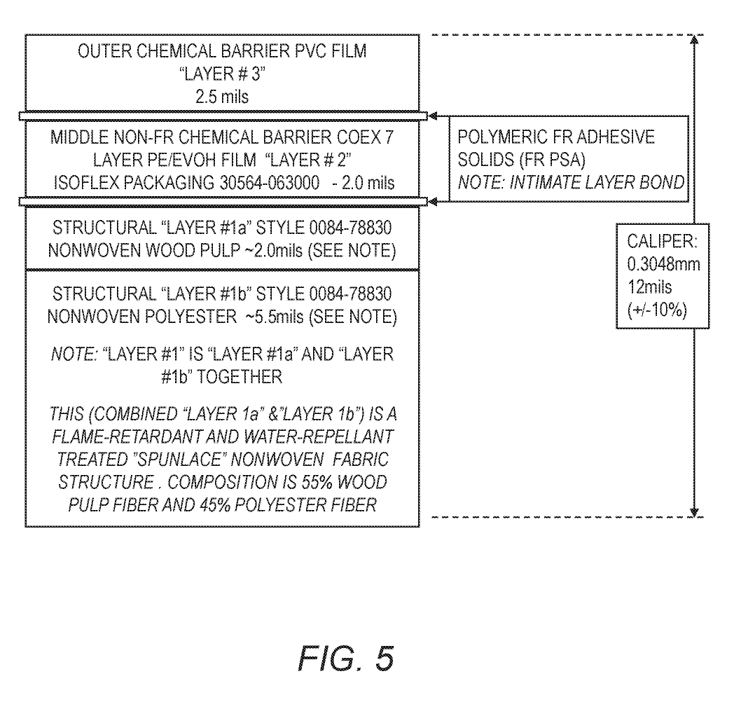

A 2.5 mil PVC Film (outer barrier “Layer 3” material) is bonded to an Isoflex Packaging film sample H6527.701, which is a 2 Mil Coextruded 7 layer Polyethylene/EVOH/Polyethylene film (chemical barrier film, non-flame retardant (non-FR) “Layer 2” material) using a flame-retardant (FR) pressure sensitive adhesive (FR PSA) compound. Subsequently, this structure is bonded to PFG Style 0084-78830 nonwoven fabric (Structural FR “Layer 1” material) using a FR PSA coating. A diagram of the composite is shown, in FIG. 5.

From the exterior to interior in reference to a user, the composite is organized as follows: PVC Film/FR. Adhesive/Coextruded Polyethylene-EVOH (7 layer)/FR Adhesive/FR Finished Wood Pulp Polyester Nonwoven.

### Description Structural FR “Layer 1” Material of the Laminated Composite: PFG Style 0084-78830 Construction Details.

A phosphate fire retardant additive, sold as Spartan 880 FR, is applied to a 2.13 osy Sontara Jacob Holm spunlace wood pulp/polyester fabric. The fabric is then dried on a pin tenter. The dry solids add-on of the Spartan 880 FR is about 27 percent by weight of the fabric. This nonwoven fabric is known in the garment industry as Precision Fabrics Softguard WRFR Spunlace 55% Woodpulp/45% Polyester. The spunlace nonwoven fabric is treated with a flame retardant and water repellant finish. This fabric is used in the last step of the laminating process as the nonwoven fabric for the Structural FR “Layer 1” material of resulting laminated composite.

### Description of Steps:

1. An aqueous-based flame retardant pressure sensitive adhesive (FR PSA) is applied to the H6527.701 2 mil Coex PE/EVOH/PE film by a #3 Meyer Rod. The Co-ex film is mounted on a true flat and level surface where the coating adhesive is applied by dragging the aqueous based mixture in front of the Meyer Rod in a manner that leaves the desired amount of wet material on the 2 mil Coex film (about 0.5 to 1.0 oz./sq.yd, wet adhesive.) The wet adhesive coated film is mounted on a drying frame, and is then dried in a circulating air oven to create a pressure sensitive adhering surface that bonds upon contact with the second layer film under heat and pressure.
2. The prior-coated H6527.701 2 mil Coex PE/EVOH/PE film (“Layer 2”) is laid in a flat manner upon the 2.5 mil PVC film (“Layer 3”).
3. The two films are then processed through a belt laminator. The bi-laminate film under the laminator belts is under pressure and reaches a temperature of about 160 to 180 degrees Fahrenheit (F) for 15 to 25 seconds to produce a flat laminate with adequate adhesion for the next step.
4. The Coex side of the resulting bi-laminate film composite is then coated with the same FR PSA, and dried in a circulating air oven to create a pressure sensitive adhering surface to be bonded to the wood-pulp side of the 0084 nonwoven fabric.
5. The prior coated and dried side of the bilaminate film is laid in a flat manner upon the wood pulp side of the Style 0084 Soft-Guard WRFR Nonwoven.
6. The composite laminate of step five is then processed under the laminator belts at about 160 to 180 F for 15 to 25 seconds to produce a flat tri-laminate with adequate adhesion.

### Example 2

This composite employs the same materials as Example 1 above, but was carried out on commercial scale equipment. This composite has been tested extensively and found to pass the standards cited throughout this document which include NFPA 701 2015 Method 1, ASTM F23 F739 Permeation Test with F23 F1001 List of Chemicals and ASTM F23 F903 Liquid Penetration and equivalent European and world-wide standards. Table 1 provides the composition details for the composite and a diagram of the composite is shown in FIG. 5.

TABLE 1
Composition details for the composite.

| | % by weight +/− | | Basis weight/caliper |
|---|---|---|---|
| Component | 10% | PFG Style | (+/−10%) |
| 2.5 mil PVC Film | 34.6 | 30561-063000 | 2.43osy or 82.4 |
| (“Layer 3”material) | | Presco | GSM/0.002″ or .0508 mm |
| Polymeric FR adhesive | 5.1 | Adhesive comprising a blocked | 0.35 osy or 11.9 GSM |
| solids (FR PSA) | | isocyanate, defoamer, a low | intimately bonded/ |
| | | glass transition point adhesive | assume 0″ on interface |
| | | binder, and a dispersion of | |
| | | antimony trioxide and | |
| | | brominated flame retardants. | |
| Polyethylene/EVOH | 22.5 | 30564-063000 | 1.6osy or 54.3 GSM/ |
| 7layer Co-extruded | | Isoflex Packaging Inc. | |
| NON FR film (“Layer 2” | | | |
| material) | | | |
| Polymeric FR adhesive | 5.1 | Adhesive comprising a blocked | 0.35 osy or 11.9 GSM |
| Solids (FR PSA) | | isocyanate, defoamer, a low | intimately bonded/ |
| | | glass transition point adhesive | assume 0″ on interface |
| | | binder, and a dispersion of | |
| | | antimony trioxide and | |
| | | brominated flame retardants. | |
| Finished Wood pulp | 18.0 | 0084-7883-061000 Finished | 1.29 osy or |
| entangled paper side | | Spunlace process Woodpulp | 43.7GSM/~.002″ or |
| or cellulosic layer of | | entangled paper side to | 0.0508 mm |
| Nonwoven Base | | adhesive - portion of “Layer 1” | |
| “Layer 1a” material | | | |
| Finished Polyester | 14.7 | 0084-7883-061000 Finished | 1.06 osy or 35.9 gsm/ |
| Staple Fiber side of | | Spunlace process Polyester | ~0.0055″ or 0.1397 mm |
| Nonwoven base | | entangled Staple side to inside | |
| “Layer 1b” material | | garment - portion of “Layer 1” | |
| Total: | 100 | PEG style 6493-54009-056000 | 6.89osy +/− 10% |
| | | (Example 2, FIG. 5) | or 233.6GSM +/− 10%/ |
| | | | 0.012″ or .3048 mm +/− |
| | | | 10% |

Description of Steps:
1. A pressure sensitive adhesive (PSA) containing flame retardant (FR PSA) is applied at 45 to 60 Grams per Square Meter (1.33 to 1.77 osy) to a clear 2 mil PE/EVOH/PE Coextruded film. The FR PSA is dried and then bonded to a 2.5 mil PVC film (basis weight is around 81 to 85 grams per square meter or 2.39 to 2.51 osy). The aqueous based adhesive precursor of the PSA is applied by a rotogravure print process. The adhesive is then dried in a radiant or circulating air oven to create a pressure sensitive adhering surface that bonds upon contact with the second film. The resulting mass of dry adhesive add on is between approximately 10 to 13.6 grams per square meter (0.29 to 0.40 osy). The marriage or bonding of the two film components is further assisted by preheating the webs and conveying them through heated nip rolls. The resulting bi-laminate then proceeds to step two.
2. The “Layer 2” side of the resulting bi-laminate film composite is coated with FR PSA and dried in a circulating air oven to create a pressure sensitive adhering surface that bonds upon contact with the wood-pulp side of the aforementioned 0084 nonwoven fabric. The bonding of the bi-laminate coated film precursor and the nonwoven substrate is improved by nipping the layers together at about 120 to 190 degrees Fahrenheit.
3. The resulting tri-laminate composite exhibits a basis weight of approximately 233.6 grams per square meter (6.89 osy) and is approximately 0.016 inches in thickness (0.4064 mm). The tri-laminate from step 2 is then calendared to adjust the properties of the laminated composite. The calendaring process makes the fabric thinner, and reduces both the handle-o-meter (reduces stiffness) and coefficient of friction. (reduces roughness) of the laminated composite.

| test | Test Method | unit | average |
|---|---|---|---|
| Example 2 test data | | | |
| basis weight | INDA/EDANA NWSP | oz./sq.yd. | 6.89 +/− 10% |
| | 130.1 | | |
| caliper | INDA/EDANA NWSP | inches | 0.012 +/− .001 |
| | 120.1 | | |
| Grab MD | INDA/EDANA NWSP | lbs. | 49 |
| | 110.1 | | |
| Grab XD | INDA/EDANA NWSP | lbs. | 53 |
| | 110.1 | | |
| Mullenburst | INDA/EDANA NWSP | psi | 53 |
| | 030.1 | | |
| Trap Tear MD | INDA/EDANA NWSP | lbs. | 12 |
| | 100.2 | | |
| Trap Tear XD | INDA/EDANA NWSP | lbs. | 22 |
| | 100.2 | | |
| Bond Strength MD 3″ × 7″ | AATCC #136/ASTM D13 | gr./″ | 133 |
| | D2724 | | |
| Bond Strength XD 3″ × 7″ | AATCC #136/ASTM D13 | gr./″ | 142 |
| | D2724 | | |
| Handleometer MD | INDA/EDANA NWSP | grams | 62 |
| 4″ × 7″-20 mm gap | 090.3 | | |
| Handleometer XD | INDA/EDANA NWSP | grams | 48 |
| 4″ × 7″-20 mm gap | 090.3 | | |
| Vertical flame test | | | |
| Char length MD 0.5 lb. | NFPA 701 1989 smsc | inches | 6.5 |
| weight (12 second flame) | | | |
| After Flame MD | NFPA 701 1989 smsc | seconds | 0 |
| Burning drip MD | NFPA 701 1989 smsc | seconds | 0 |
| % weight loss MD | NFPA 701 1989 smsc | % | 8 |
| Char Length XD 0.5 lb. | NFPA 701 1989 smsc | inches | 6 |
| weight (12 second flame) | | | |
| After Flame XD | NFPA 701 1989 smsc | seconds | 0 |
| Burning Drip XD | NFPA 701 1989 smsc | seconds | 0 |
| % weight loss XD | NFPA 701 1989 smsc | % | 8 |
| % weight Loss MD | NFPA 701 2015 Method 1 | % loss | 12 |
| (45 second flame) | | | |

### Overview of Examples 3-6

Examples 1 and 2 illustrate the construction method for example composites of the present invention. Subsequent examples illustrate possible film layer substitutions and/or additions to further improve the chemical permeation resistance of composites.

Many variations of the composites may be derived, such as, for example, by adding film layers to a composite or by substituting films for either layer 2, layer 3, or for both layers. Halar@ 500LC and Tedlar® TCC15BL3 may be advantageous films for achieving a high level of chemical permeation resistance.

### Example 3

The composite of Example 3 is a variation of the composite described in Example 1, except that new films are substituted for both “Layer 2” and “Layer 3” of the composite. A 3 layer, 3 mil, coex polyolefin blend PP/EVOH/PE film is substituted for the 7 layer coex film in Example 1, and a High Molecular Weight PVC film is substituted for the regular PVC film in Example 1. These changes reduce the permeation rate of Diethylamine, Tetrahydrofuran, and gaseous 99% HCl to less than 0.1 micrograms breakthrough threshold for the 480 minute test duration.

### Example 4

The composite of Example 4 is constructed in the same manner as the composite described in Example 3 with the exception of the outer barrier “Layer 3” being a monolithic 2-mil PVF film (Tedlar TCC15BL3). The composite of Example 4 achieved less than the 0.1 microgram threshold after a 480 minute insult from methanol per ASTM F739 guidelines/ASTM F1001. While not wishing to be bound to any particular theory, this added attribute is believed to be the result of the outer “Layer 3” barrier substitution in the basic composite design from Example 3.

### Example 5

The composite of Example 5 is the same as the composite described in Example 3 except that a 25 micron PEEK (Polyetheretherketone-APTIV) film was substituted for “Layer 2” of the composite to improve the composite's resistance to methanol permeation. The addition of this film kept the methanol permeation below 0.1 micrograms in 480 minutes of insult.

### Example 6

The composite of Example 6 is similar to the composites described in Examples 3 and 5 except that a 50 micron ECTFE (copolymer of ethylene and chlorotrifluoroethylene—“Halar 500LC”) is added to the composite or substituted for layer 2. This film also enhanced the composite's resistance to methanol permeation to below the 0.1 micrograms in 480 minutes of insult.

### Example 7

Table 2 provides examples of barrier films that may be incorporated into a composite of the present invention. Some of the barrier films described in Table 2 are similar to or the same as those described in the above examples.

The lamination processes used in the examples are not intended to limit the processes that can be used for constructing a composite of the present invention. For example, corona treatment of webs, gravure coating, hot nipping, and hot calendaring were utilized for scale up of composites of the present invention. For purposes of this invention, a composite of the present invention may be constructed by any process or combination of processes known to those trained in the arts of paper manufacture, nonwovens manufacture, fabric and/or film adhesive lamination or film extrusion.

TABLE 2
Example barrier film layer descriptions.

| Film Description | Details |
|---|---|
| Coex7 layer 2 mil PE/ | 2 mil total thickness; 7 total layers of |
| EVOH film | polyethylene (PE) and polyethylene vinyl |
| | alcohol (EVOH), the layer structure being: |
| | PE/EVOH/PE/EVOH/PE/EVOH/PE |
| | (Examples 1 & 2 middle barrier “Layer 2”) |
| Coex 3 layer 3 mil | 3 mil total thickness; 3 distinct layers ~1 mil |
| polyolefin polypropylene | each, the layered film structure being: |
| (PP) blend/EVOH/PE film | Polyolefin PP blend/EVOH/PE |
| | (Examples 3 & 4 middle “Layer 2”) |
| Monolithic 2 mil PVF film | (Tedlar ® TCC15BL3) |
| | (Example 4 outer “Layer 3”) |
| Coex 3 layer 2.5 mil | 2.5 mil total thickness; 3 layers total, the |
| Polyolefin PP | layer structure being: Polyolefin PP |
| blend/EVOH/PE film | blend/EVOH/PE (“Layer 2”) |
| Coex 3 layer 2 mil | 2 mil total thickness; 3 layers, the layer |
| PE/EVOH/PE | structure being: PE/EVOH/PE Copolymer |
| copolymer film | (“Layer 2”) |
| APTIV 1000-025GS 25μ | Single layer of PEEK |
| film PolyEtherEtherKetone | (Example 5 - “Layer 2”) |
| (PEEK) | |
| Halar ® ECTFE 50μ | Single layer of Halar ® |
| film | (Example 6 - “Layer 2”) |

TABLE 3
Difference of solubility parameter and results from ASTM F739 testing.

| | | | Absolute | Absolute | | | | |
|---|---|---|---|---|---|---|---|---|
| | | | Value | Value | | | ASTM F739 | |
| | Test Liquid | | (Test | (Test | Greater | | Normalized | |
| | Sol | | Liquid | Liquid | Delta | ASTM | Breakthrough | Permeation |
| | Parameter | | Sol Para - | Sol Para - | Difference | F23 | time in min. | rate Steady |
| Chemical test Liquids | Units: | | 8.0 | 13.0 | of Sol | F739 | (>0.1 μGr./ | State Max |
| F1001 (“Permeant”) | (cal/cm³)^{1/2} | PPE Barrier layer | (PE)) | (EVOH) | Parameter | Status | cm²/min.) | μGr./cm²/min. |
| ACETONE | 9.9 | Coex7layer 2 mil | 1.9 | 3.1 | 3.1 | PASS | >480 | NONE |
| | | PE/EVOH film | | | | | | DETECTED |
| ACETONITRILE | 11.9 | Coex7layer 2 mil | 3.9 | 1.1 | 3.9 | PASS | >480 | NONE |
| | | PE/EVOH film | | | | | | DETECTED |
| CARBON DlSULFIDE | 10 | Coex7layer 2 mil | 2 | 3 | 3 | PASS | >480 | NONE |
| | | PE/EVOH film | | | | | | DETECTED |
| DICHLOROMETHANE | | Coex7layer 2 mil | 8 | 13 | 13 | PASS | >480 | NONE |
| | | PE/EVOH film | | | | | | DETECTED |
| DIETHYLAMINE (DEA) | 8 | Coex7layer 2 mil | 0 | 5 | 5 | FAIL | 130 | 5.2 |
| | | PE/EVOH film | | | | | | |
| DIETHYLAMINE (DEA) | 8 | Coex 3 layer 3 mil | 0 | 5 | 5 | PASS | >480 | NONE |
| | | Polyolefin(PP)/ | | | | | | DETECTED |
| | | EVOH/PE film | | | | | | |
| DIETHYLAMINE (DEA) | 8 | Coex 3 layer 2.5 mil | 0 | 5 | 5 | FAIL | 91 | 14.7 |
| | | Polyolefin(PP)/EVOH/ | | | | | | |
| | | PE film | | | | | | |
| DIETHYLAMINE (DEA) | 8 | Coex 3 layer 2 mil | 0 | 5 | 5 | PASS | >480 | NONE |
| | | PE/EVOH/PE | | | | | | DETECTED |
| | | copolymer film | | | | | | |
| DIMETHYLFORMAMIDE | 12.14 | Coex7layer 2 mil | 4.14 | 0.86 | 4.14 | PASS | >480 | NONE |
| (DMF) | | PE/EVOH film | | | | | | DETECTED |
| ETHYL ACETATE | 9.1 | Coex7layer 2 mil | 1.1 | 3.9 | 3.9 | PASS | >480 | NONE |
| | | PE/EVOH film | | | | | | DETECTED |
| N-HEXANE | 7.3 | Coex7layer 2 mil | 0.7 | 5.7 | 5.7 | PASS | >480 | NONE |
| | | PE/EVOH film | | | | | | DETECTED |
| METHANOL | 14.5 | Coex7layer 2 mil | 6.5 | 1.5 | 6.5 | FAIL | 25 | 1.65 |
| | | PE/EVOH film | | | | | | |
| METHANOL | 14.5 | Coex 3 layer 3 mil | 6.5 | 1.5 | 6.5 | FAIL | 64 | 2.24 |
| | | Polyolefin(PP)/EVOH/ | | | | | | |
| | | PE film | | | | | | |
| METHANOL | 14.5 | Coex 3 layer 2.5 mil | 6.5 | 1.5 | 6.5 | FAIL | 79 | 3.74 |
| | | Polyolefin/EVOH/PE | | | | | | |
| | | film | | | | | | |
| METHANOL | 14.5 | Coex 3 layer 2 mil | 6.5 | 1.5 | 6.5 | FAIL | 63 | 3.49 |
| | | PE/EVOH/PE | | | | | | |
| | | copolymer film | | | | | | |
| METHANOL | 14.5 | Polyetheretherketone | 6.5 | 1.5 | 6.5 | PASS | >480 | NONE |
| | | (PEEK)25μ film | | | | | | DEFECTED |
| METHANOL | 14.5 | Halar ECTFE 50μ film | 6.5 | 1.5 | 6.5 | PASS | >480 | NONE |
| | | | | | | | | DETECTED |
| METHANOL | 14.5 | Monolithic 2 mil PVF | Not | Not | Not found | PASS | >480 | NONE |
| | | film (“Tedlar”) | found | found | | | | DETECTED |
| NITROBENZENE | 10 | Coex7layer 2 mil | 2 | 3 | 3 | PASS | >480 | NONE |
| | | PE/EVOH film | | | | | | DETECTED |
| SODIUM HYDROXIDE | | Coex7layer 2 mil | 8 | 13 | 13 | PASS | >480 | NONE |
| 50% | | PE/EVOH film | | | | | | DETECTED |
| SULFURIC ACID | | Coex7layer 2 mil | 8 | 13 | 13 | PASS | >480 | NONE |
| 93.1% 66°B | | PE/EVOH film | | | | | | DETECTED |
| TETRACHLOROETHYLENE | 9.3 | Coex7layer 2 mil | 1.3 | 3.7 | 3.7 | PASS | >480 | NONE |
| (perc) | | PE/EVOH film | | | | | | DETECTED |
| TETRAHYDROFURAN | 9.1 | Coex7layer 2 mil | 1.1 | 3.9 | 3.9 | FAIL | 13 | 2.51 |
| (THF) | | PE/EVOH film | | | | | | |
| TETRAHYDROFURAN | 9.1 | Coex 3 layer 3 mil | 1.1 | 3.9 | 3.9 | PASS | >480 | NONE |
| (THF) | | Polyolefin(PP)/ | | | | | | DETECTED |
| | | EVOH/PE film | | | | | | |
| TETRAHYDROFURAN | 9.1 | Coex 3 layer 2.5 mil | 1.1 | 3.9 | 3.9 | PASS | >480 | NONE |
| (THF) | | Polyolefin(PP)/EVOH/ | | | | | | DETECTED |
| | | PE film | | | | | | |
| TETRAHYDROFURAN | 9.1 | Coex 3 layer 2 mil | 1.1 | 3.9 | 3.9 | PASS | >480 | NONE |
| (THF) | | PE/EVOH/PE | | | | | | DETECTED |
| | | copolymer film | | | | | | |
| TOLUENE | 8.9 | Coex7layer 2 mil | 0.9 | 4.1 | 4.1 | PASS | >480 | NONE |
| | | PE/EVOH film | | | | | | DETECTED |
| | | | 8 | 13 | 13 | | | |
| Chemical test Gases | | | 8 | 13 | 13 | | | |
| F1001 | | | | | | | | |
| AMMONIA ANHYDROUS | | Coex7layer 2 mil | 8 | 13 | 13 | PASS | >480 | NONE |
| | | PE/EVOH film | | | | | | DETECTED |
| 1,3-BUTADIENE inhibited | | Coex7layer 2 mil | 8 | 13 | 13 | PASS | >480 | NONE |
| 99% | | PE/EVOH film | | | | | | DETECTED |
| CHLORINE 99.5% | | Coex7layer 2 mil | 8 | 13 | 13 | PASS | >480 | NONE |
| | | PE/EVOH film | | | | | | DETECTED |
| ETHYLENE OXIDE 99.7% | | Coex7layer 2 mil | 8 | 13 | 13 | PASS | >480 | NONE |
| | | PE/EVOH film | | | | | | DETECTED |
| HYDROGEN CHLORIDE | | Coex7layer 2 mil | 8 | 13 | 13 | FAIL | 182 | 0.156 |
| 99% | | PE/EVOH film | | | | | | |
| HYDROGEN CHLORIDE | | Coex 3 layer 3 mil | 8 | 13 | 13 | PASS | >480 | NONE |
| 99% | | Polyolefin(PP)/ | | | | | | DETECTED |
| | | EVOH/PE film | | | | | | |
| HYDROGEN CHLORIDE | | Coex 3 layer 2.5 mil | 8 | 13 | 13 | PASS | >480 | NONE |
| 99% | | Polyolefin(PP)/EVOH/ | | | | | | DETECTED |
| | | PE film | | | | | | |
| HYDROGEN CHLORIDE | | Coex 3 layer 2 mil | 8 | 13 | 13 | FAIL | 310 | 1.61 |
| 99% | | PE/EVOH/PE | | | | | | |
| | | copolymer film | | | | | | |
| METHYL CHLORIDE | 9.7 | Coex7layer 2 mil | 1.7 | 3.3 | 3.3 | PASS | >480 | NONE |
| 99.5% | | PE/EVOH film | | | | | | DETECTED |

### Example 8

Additional example composites of the present invention include, but are not limited to, the following.

### Example Embodiment 8A

Layer 1: A 1-6 osy, 4-25 mils FR treated PET/woodpulp (cellulose) spunlace fabric with a first sublayer comprising polyester and a second sublayer comprising woodpulp or cellulose, wherein a surface of the second sublayer is adhered to Layer 2

Adhesive 1 (bonds Layer 1 to Layer 2): A 0.25-1.5 osy, 0.01-3 mils FR PSA (elastomeric acrylic adhesive intimate continuous coated layer)

Layer 2: A 1-3.5 osy, 0.5-5 mils polyethylene/EVOH co-ex film (non-FR)

Adhesive 2 (bonds Layer 2 to Layer 3): A 0.25-1.5 osy, 0.01-3 mils FR PSA (elastomeric acrylic adhesive intimate continuous coated layer)

Layer 3: A 1-6 osy, 0.2-6 mils PVC outer chemical barrier FR film

### Example Embodiment 8B

Layer 1: A 1-6 osy, 4-25 mils FR treated PET/woodpulp (cellulose) spunlace fabric with a first sublayer comprising polyester and a second sublayer comprising woodpulp or cellulose, wherein a surface of the second sublayer is adhered to Layer 2

Adhesive 1 (bonds Layer 1 to Layer 2): A 0.03-0.8 osy amorphous poly-alpha-olefin copolymer (APAO) PSA adhesive intimate discontinuous coated layer

Layer 2: A 1.0-3.5 osy, 0.5-5.0 mil polyethylene/EVOH co-ex film (non-FR)

Adhesive 2 (bonds Layer 2 to Layer 3): A 0.25-2.5 osy, 0.1-3.0 mil FR PSA (elastomeric acrylic adhesive intimate continuous coated layer)

Layer 3: A 1.0-6.0 osy, 0.2-6.0 mil PVC outer chemical barrier FR film

### Example Embodiment 8C

Layer 1: A 1-6 osy, 4-25 mils FR treated PET/woodpulp (cellulose) spunlace fabric with a first sublayer comprising polyester and a second sublayer comprising woodpulp or cellulose, wherein a surface of the second sublayer is adhered to Layer 2

Adhesive 1 (bonds Layer 1 to Layer 2): A 0.25-1.5 osy, 0.01-3.0 mil FR PSA (elastomeric acrylic adhesive intimate continuous coated layer)

Layer 2: A 1.0-3.5 osy, 0.5-5.0 mil polyethylene/EVOH co-ex film (non-FR)

Adhesive 2 (bonds Layer 2 to Layer 3): none

Layer 3: 1.0-6.0 osy, 0.2-6 mils intimate self-adhering durable continuous outer chemical barrier coating comprising ethyl methacrylic acid (FR filled, hot melt extruded)

### Example Embodiment 8D

Layer 1: A 1-6 osy, 4-25 mils FR treated PET/woodpulp (cellulose) spunlace fabric with a first sublayer comprising polyester and a second sublayer comprising woodpulp or cellulose, wherein a surface of the second sublayer is adhered to Layer 2

Adhesive 1 (bonds Layer 1 to Layer 2): A 0.25-1.5 osy FR PSA (elastomeric acrylic adhesive intimate continuous coated layer)

Layer 2: A 1.0-3.5 osy, 0.5-5.0 mil polyethylene/EVOH co-ex film (non-FR)

Adhesive 2 (bonds Layer 2 to Layer 3): none

Layer 3: 1.0-6.0 osy, 0.2-6 mils intimate self-adhering durable continuous outer chemical barrier coating comprising PVDC coating (applied wet/dried/cured)

The foregoing is illustrative of the present invention, and is not to be construed as limiting thereof. The invention is defined by the following claims, with equivalents of the claims to be included therein. All publications, patent applications, patents, patent publications, and other references cited herein are incorporated by reference in their entireties for the teachings relevant to the sentence and/or paragraph in which the reference is presented.

1. A multi-layered composite comprising:
a first layer comprising a nonwoven fabric;
a second layer comprising a non-flame retardant chemical barrier polymeric film; and
a third layer comprising a polymeric film;
wherein the first layer is adhered to the second layer with a first flame retardant adhesive and the second layer is adhered to the third layer with a second flame retardant adhesive.

2.-15. (canceled)

16. A multi-layered composite comprising:
a first layer comprising a nonwoven fabric;
a second layer comprising a non-flame retardant chemical barrier polymeric film; and
a third layer comprising a flame retardant coating;
wherein the first layer is adhered to the second layer with a first flame retardant adhesive and the second layer is adhered to the third layer with a second flame retardant adhesive.

17.-22. (canceled)

23. A multi-layered composite comprising:
a first layer comprising a nonwoven fabric;
a second layer comprising a non-flame retardant chemical barrier polymeric film; and
a third layer comprising a polymeric film;
wherein the first layer is adhered to the second layer with a first adhesive.

24. The multi-layered composite of claim 23, wherein the first adhesive is not flame retardant.

25. The multi-layered composite of claim 23, wherein the first adhesive is flame retardant.

26. The multi-layered composite of claim 23, wherein the second layer is adhered to the third layer with a second adhesive and the second adhesive is flame retardant.

27. The multi-layered composite of claim 23, wherein the second layer is in direct contact with the third layer.

28. The multi-layered composite of claim 23, wherein the first adhesive is a discontinuous layer between the first layer and the second layer.

29. The multi-layered composite of claim 23, wherein the nonwoven fabric comprises a fire retardant additive.

30. The multi-layered composite of claim 23, wherein the nonwoven fabric comprises cellulosic fibers and synthetic fibers.

31. The multi-layered composite of claim 30, wherein the cellulosic fibers include woodpulp fibers and the synthetic fibers include polyester fibers.

32. The multi-layered composite of claim 23, wherein the non-flame retardant chemical barrier polymeric film includes two or more layers, optionally wherein there is a space and/or absorbent media between two of the two or more layers.

33. (canceled)

34. The multi-layered composite of claim 23, wherein the non-flame retardant chemical barrier polymeric film comprises a coextruded polyethylene-ethylene vinyl alcohol.

35. The multi-layered composite of claim 23, wherein the third layer comprises a polyvinyl chloride film.

36. The multi-layered composite of claim 23, wherein the non-flame retardant chemical barrier polymeric film has a difference in solubility parameter that is at least about 3.0 (calories per cm³)^{1/2} for at least one chemical listed in ASTM F23 F1001.

37. The multi-layered composite of claim 23, wherein the non-flame retardant chemical barrier polymeric film comprises two or more layers and at least one of the two or more layers has a difference in solubility parameter that is at least about 3.0 (calories per cm³)^{1/2} for at least one chemical listed in ASTM F23 F1001.

38. The multi-layered composite of claim 23, wherein the composite has a chemical hold out of at least 8 hours in accordance with ASTM F23 F739 and ISO 6529/EN 14325 Chemical Permeation using at least one chemical listed in ASTM F23 F1001.

39. The multi-layered composite of claim 23, wherein the composite passes NFPA 701-2015 Method 1 and/or meets the requirements of NFPA 2113.

40. The multi-layered composite of claim 23, wherein the composite has at least 12.0 pounds of grab tensile according to INDA IST 110.3-92.

41. A protective garment comprising the composite of claim 23.

42. (canceled)
